(19) United States
(12) Patent Application Publication
(10) Pub. No.: US 2004/0074072 A1
(43) Pub. Date: Apr. 22, 2004

(54) Method for manufacturing gas sensor elements

(75) Inventor: Atsushi Iwata, Kuwana-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/680,302

(22) Filed: Oct. 8, 2003

(30) Foreign Application Priority Data
Oct. 16, 2002 (JP) 2002-302212

(51) Int. Cl. H05H 1/26; H01G 9/00

(52) U.S. Cl. 29/25.03; 427/446

(57) ABSTRACT

In a method of manufacturing gas sensor elements each having a solid-electrolyte body and a protective layer, a radius R of the solid-electrolyte body is measured at a radius measurement position A of a protective-layer-forming surface of the solid-electrolyte body, a molten protective-layer material is sprayed on the protective-layer-forming surface by means of a plasma thermal-spraying equipment to form a protective layer, a radius S of the solid-electrolyte body inclusive of the protective layer is measured at a point B of intersection of a normal at the radius measurement position A with the surface of the protective layer, and the amount of spray of the protective-layer material in the plasma thermal-spraying equipment is controlled regarding a difference between the radius S and the radius R as the thickness of the protective layer and on the basis of this thickness, to form each protective layer in a desired thickness.

### BACKGROUND OF THE INVENTION

1. Field of the Invention

This invention relates to a method for manufacturing gas sensor elements each having a solid-electrolyte body, an electrode provided on its surface, and a protective layer which covers the surface of the solid-electrolyte body.

2. Description of the Prior Art

As a gas sensor element used in measuring gas concentration such as oxygen concentration in measurement gases, a structure is known which has i) a cylindrical and substantially tumbler-shaped solid-electrolyte body which has a closed-end head portion and, on the side opposite to the head portion, an open-ended base tail portion, ii) an electrode provided on the surface of the solid-electrolyte body and iii) a porous protective layer which covers the surface of the electrode.

The protective layer of such a gas sensor element has the function to protect the electrode and solid-electrolyte body from poisoning substances contained in measurement gases and also has the function to make a measuring-target measurement gas stay on the electrode surface for a certain time to gain the time for which the measuring-target measurement gas reacts on the electrode surface.

Hence, the performance of the protective layer has a great influence on gas exchange taking place on the electrode surface, and plays an important role in the determination of responsivity in gas sensor elements. Thus, a manufacturing method which can make the protective layer retain its quality and properties constantly is important in order to control responsivity scattering (non-uniformity in responsivity among products) of gas sensor elements.

Conventionally, for example, a manufacturing method disclosed in Japanese Patent Application Laid-open No. 2001-124725 is proposed in order to control responsivity scattering of gas sensor elements.

In this manufacturing method, the amount of thermal spraying per unit time is found from i) changes in weight of a gas sensor element before and after the step of forming a protective layer and ii) time of plasma thermal spraying used to form the protective layer, and the output of the plasma thermal spraying is so controlled as to be kept within a stated range, to control the responsivity scattering of gas sensor elements.

However, solid-electrolyte bodies have uneven surfaces (how the surfaces are uneven are illustrated in FIGS. 8 and 9 referenced later, in an exaggerated manner so as to be intelligible), and hence electrodes formed on the surfaces of such solid-electrolyte bodies also have uneven surfaces reflecting the uneven surfaces of the solid-electrolyte bodies.

Thus, in the protective-layer thickness control method as described in the above prior art, it has been difficult to deal with the uneven surfaces the solid-electrolyte bodies or electrodes have, and it has been insufficient to control thickness scattering (non-uniformity in thickness among products) of protective layers.

### SUMMARY OF THE INVENTION

The present invention was made taking account of such a problem the prior art has had. Accordingly, an object of the present invention is to provide a method for manufacturing gas sensor elements with less responsivity scattering.

As a first embodiment, the present invention provides a method for manufacturing gas sensor elements each having i) a cylindrical and substantially tumbler-shaped solid-electrolyte body which has a closed-end head portion and, on the side opposite to the head portion, an open-ended base tail portion, ii) an electrode provided on the surface of the solid-electrolyte body and iii) a porous protective layer which covers the surface of the electrode; the method comprising:

forming the electrode on an electrode-forming surface of the solid-electrolyte body;

subsequently measuring a radius R of the solid-electrolyte body, at a radius measurement position A of a protective-layer-forming surface of the solid-electrolyte body;

spraying a molten protective-layer material on the protective-layer-forming surface by means of a plasma thermal-spraying equipment to form the protective layer;

measuring a radius S of the solid-electrolyte body inclusive of the protective layer, at a point B of intersection of a normal at the radius measurement position A with the surface of the protective layer; and

controlling the amount of spray of the protective-layer material in the plasma thermal-spraying equipment, regarding a difference between the radius S and the radius R as the thickness of the protective layer and on the basis of this thickness, to form each protective layer in a desired thickness.

As a second embodiment, the present invention provides a method for manufacturing gas sensor elements each having i) a cylindrical and substantially tumbler-shaped solid-electrolyte body which has a closed-end head portion and, on the side opposite to the head portion, an open-ended base tail portion, ii) an electrode provided on the surface of the solid-electrolyte body and iii) a porous protective layer which covers the surface of the electrode; the method comprising:

forming the electrode on an electrode-forming surface of the solid-electrolyte body;

subsequently measuring radii T1,T2 . . . of the solid-electrolyte body at a plurality of radius measurement positions D1,D2 selected along a peripheral circle C on a protective-layer-forming surface of the solid-electrolyte body while rotating the solid-electrolyte body around its axis extending along the axial direction connecting the base tail portion and the head portion;

spraying a molten protective-layer material on the protective-layer-forming surface by means of a plasma thermal-spraying equipment to form the protective layer;

measuring radii U1,U2 . . . of the solid-electrolyte body inclusive of the protective layer, at points E1,E2 . . . of intersection of normals at the radius measurement positions D1,D2 . . . with the surface of the protective layer; and

controlling the amount of spray of the protective-layer material in the plasma thermal-spraying equipment, regarding an average of differences between the radii T1,T2 . . . at the respective radius measurement positions and the radii U1,U2 . . . at the respective intersection points corresponding to the former as the thickness of the protective layer and on the basis of this thickness, to form each protective layer in a desired thickness.

### BRIEF DESCRIPTION OF THE DRAWINGS

FIG. 1 is a partially cutaway sectional illustration of a gas sensor element in Example 1.

FIG. 2 illustrates a thermal-spraying equipment and how to form a protective layer by thermal spraying in Example 1.

FIG. 3 illustrates a radius measurement position and a solid-electrolyte body on which a protective layer has not been formed, in Example 1.

FIG. 4 illustrates the radius measurement position and a solid-electrolyte body on which the protective layer has been formed, in Example 1.

FIG. 5 illustrates how to measure the radius of the solid-electrolyte body before and after formation of the protective layer in Example 1.

FIG. 6 illustrates a protective-layer forming apparatus in Example 2.

FIG. 7 illustrates radius measurement positions lining on a peripheral circle in Example 2.

FIG. 8 is a sectional illustration of radius measurement positions and a solid-electrolyte body on which a protective layer has not been formed, in Example 3.

FIG. 9 is a sectional illustration of radius measurement positions and the solid-electrolyte body on which the protective layer has been formed, in Example 3.

### DESCRIPTION OF THE PREFERRED EMBODIMENTS

The gas sensor elements manufactured by the manufacturing method of the present invention are gas sensor elements each having i) a cylindrical and substantially tumbler-shaped solid-electrolyte body which has a closed-end head portion and, on the side opposite to the head portion, an open-ended base tail portion, ii) an electrode provided on the surface of the solid-electrolyte body and iii) a porous protective layer which covers the surface of the electrode.

In the first embodiment of the present invention, as will be detailed in Example 1 given later, the gas sensor elements are each manufactured by forming the electrode in a thickness of from 1.0 μm to 1.4 μm on an electrode-forming surface of the cylindrical and substantially tumbler-shaped solid-electrolyte body, and forming the protective layer in a thickness of from 55 μm to 85 μm on the protective-layer-forming surface by plasma thermal spraying.

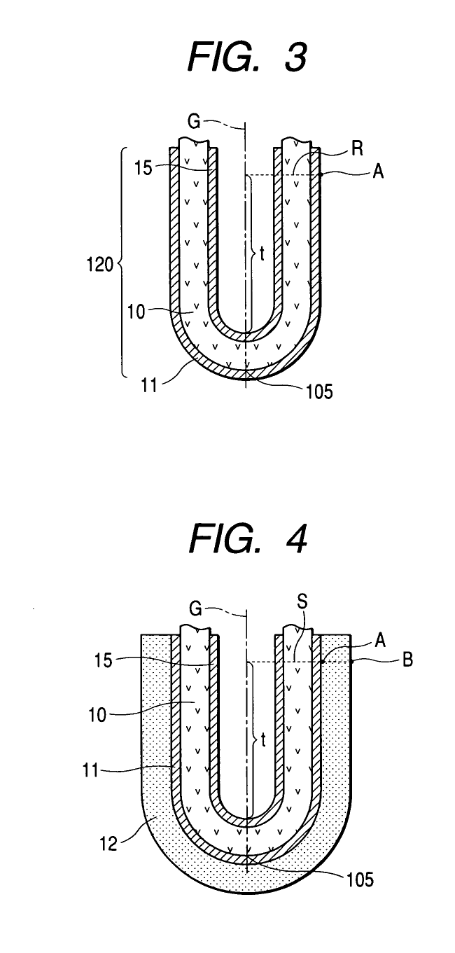

Before this plasma thermal spraying, a radius R of the solid-electrolyte body (inclusive of the electrode layer) is measured at a radius measurement position A which is an arbitrary point selected appropriately from a protective-layer-forming surface of the solid-electrolyte body (see FIG. 3 as referenced later).

In the present specification and claims, the solid-electrolyte body inclusive of the electrode layer is also called “solid-electrolyte body” alike.

Thereafter, a protective-layer material is sprayed on the protective-layer-forming surface by means of a plasma thermal-spraying equipment to form the protective layer, where a radius S of the solid-electrolyte body inclusive of the protective layer is measured at an intersection point B which intersects on the protective layer surface with a normal extending from the radius measurement position A (see FIG. 4 as referenced later).

Therefore, a difference between S and R corresponds to the thickness of the protective layer at the radius measurement position A and intersection point B.

In the first embodiment of the present invention, this thickness is regarded as a typical thickness of the protective layer, and the amount of spray of the protective-layer material in the plasma thermal-spraying equipment is controlled on the basis of this thickness. Thus, the protective layer formed by plasma thermal spraying can be obtained in a desired thickness.

In the first embodiment of the present invention, as being different from the prior art, such a typical thickness of the protective layer is directly measured and the amount of spray is controlled on the basis of this thickness. Hence, a protective layer having a desired thickness can be obtained with ease. Thus, this enables easier thickness control of the protective layer, and gas sensor elements manufactured by the method according to the first embodiment of the present invention can have a small thickness scattering of protective layers one another.

In the second embodiment of the present invention as well, the gas sensor elements are each manufactured by forming the electrode in a thickness of from 1.0 μm to 1.4 μm on an electrode-forming surface of the cylindrical and substantially tumbler-shaped solid-electrolyte body, and forming the protective layer in a thickness of from 55 μm to 85 μm on the protective-layer-forming surface by plasma thermal spraying.

Before this plasma thermal spraying, radii T1,T2 . . . of the solid-electrolyte body (inclusive of the electrode layer) are measured at a plurality of radius measurement positions D,D2 . . . selected along an arbitrary peripheral circle C on a protective-layer-forming surface in the solid-electrolyte body (see FIG. 8, as referenced later).

Herein, the peripheral circle C refers to a line of intersection of the side face of the solid-electrolyte body with a plane perpendicular to the axis extending from the head portion to the base tail portion of the solid-electrolyte body, and is usually substantially circular.

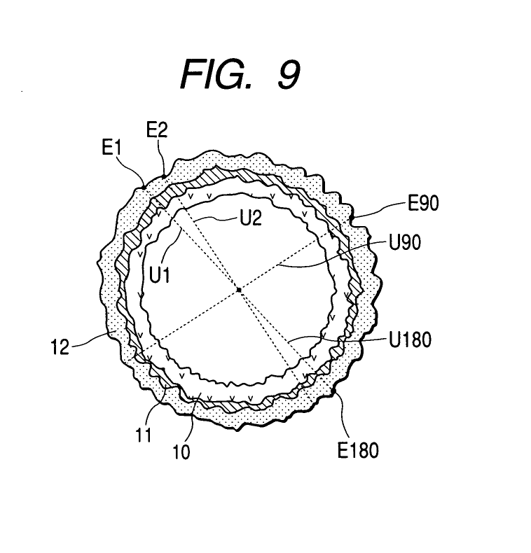

Thereafter, a protective-layer material is sprayed on the protective-layer-forming surface by means of a plasma thermal-spraying equipment to form the protective layer, where radii U1,U2 . . . of the solid-electrolyte body inclusive of the protective layer are measured at points E1,E2 . . . of intersection of normals at the radius measurement positions D1,D2 . . . with the surface of the protective layer (see FIG. 9, as referenced later).

Therefore, a difference between T1 and U1, T2 and U2 and so on each correspond to the thickness of the protective layer at each radius measurement position.

In the second embodiment of the present invention, the thicknesses at the respective radius measurement positions are averaged, and their average value is regarded as a typical thickness of the protective layer, and the amount of spray of the protective-layer material in the plasma thermal-spraying equipment is controlled on the basis of this average thickness. Thus, the protective layer formed by plasma thermal spraying can be obtained in a desired thickness.

In the second embodiment of the present invention, as being different from the prior art, such a typical thickness of the protective layer is directly measured and the amount of spray is controlled on the basis of this thickness. Hence, a protective layer having a desired thickness can be obtained with ease. Thus, this enables easier thickness control of the protective layer, and gas sensor elements manufactured by the method according to the second embodiment of the present invention can have a small thickness scattering of protective layers one another.

In addition, in the second embodiment of the present invention, the radii are measured while rotating the solid-electrolyte body, and hence the thickness of the protective layer can be measured in a good efficiency at a large number of radius measurement positions.

The larger the number of radius measurement positions is made, the more accurately the thickness of the protective layer can be measured. Accordingly, even especially when the electrode surface and the surface of the solid-electrolyte body have a large unevenness, gas sensor elements having protective layers with desired thickness and with small scattering (non-uniformity) can be manufactured (Example 3 given later is an example in which radius measurement positions are 180 spots).

As described above, according to the first and second embodiments, methods can be provided by which gas sensor elements with less responsivity scattering can be manufactured.

In the gas sensor elements obtained by the manufacturing methods according to the first and second embodiments of the present invention, the solid-electrolyte body may be constituted of a conventionally known, oxygen-ion-conductive zirconia ceramic; and the electrode, a noble-metal electrode material containing Pt or the like.

The protective layer has the function to protect the electrode and solid-electrolyte body from poisoning substances contained in measurement gases and also has the function to make a measuring-target measurement gas stay on the electrode surface for a certain time to gain the time for which the measuring-target measurement gas reacts on the electrode surface. It may be constituted of any desired inorganic material. For example, a spinel such as MgO.Al₂O₃ may be used.

The plasma thermal spraying may be carried out by introducing the protective-layer material into high-temperature plasma flame shot from a plasma gun, to cause the material to melt by the plasma flame, and spraying the molten material on the protective-layer-forming surface of the solid-electrolyte body. Thereafter, the molten protective-layer material hardens to make the protective layer.

The present invention is described below in greater detail by giving Examples, with reference to the accompanying drawings.

### EXAMPLE 1

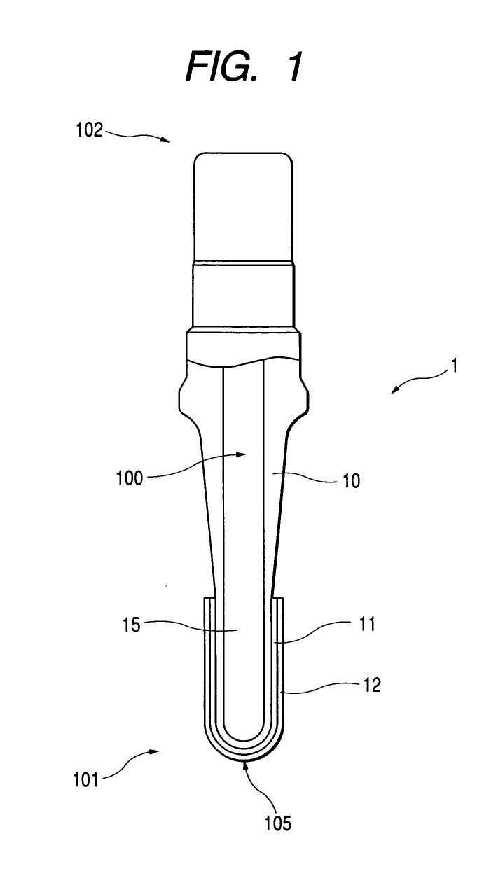

In this Example, described is a method for manufacturing gas sensor elements which are each as shown in FIG. 1 a gas sensor element 1 having i) a cylindrical and substantially tumbler-shaped solid-electrolyte body 10 which has a closed-end head portion 101 and, on the side opposite to the head portion 101, an open-ended base tail portion 102, ii) an electrode 11 provided on the surface of the solid-electrolyte body 10 and iii) a porous protective layer 12 which covers the surface of the electrode 11.

More specifically, the electrode 10 is formed on an electrode-forming surface of the solid-electrolyte body 10. Subsequently, as shown in FIG. 3, a radius R of the solid-electrolyte body 10 (inclusive of the electrode layer 11; the same applies hereinafter) is measured at a radius measurement position A of a protective-layer-forming surface 120 of the solid-electrolyte body 10.

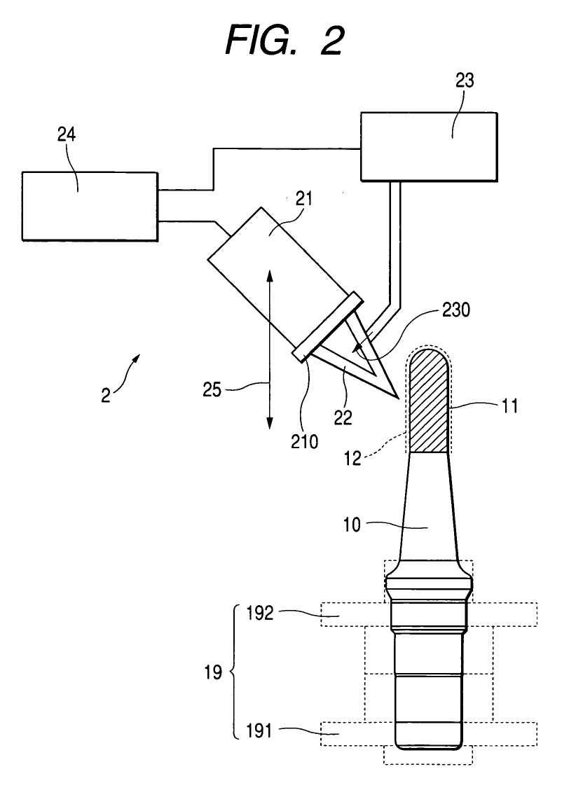

As shown in FIG. 2, a molten protective-layer material 230 is sprayed on the protective-layer-forming surface 120 by means of a plasma thermal-spraying equipment 2 to form the protective layer 12.

As shown in FIG. 4, a radius S of the solid-electrolyte body 10 inclusive of the protective layer 12 is measured at a point B of intersection of a normal at the radius measurement position A with the surface of the protective layer 12.

Incidentally, the surfaces of the solid-electrolyte body 10 and so forth are flatly illustrated in FIGS. 3 and 4, but actually have fine unevenness.

Then, the amount of spray of the protective-layer material 230 in the plasma thermal-spraying equipment 2 is controlled regarding a difference between the radius S and the radius R as the thickness of the protective layer 12 and on the basis of this thickness, to form each protective layer 12 in a desired thickness.

The foregoing is detailed below.

As shown in FIG. 1, the gas sensor element 1 has the cylindrical and substantially tumbler-shaped solid-electrolyte body 10 which has a closed-end head portion 101 and, on the side opposite to the head portion 101, an open-ended base tail portion 102. It also has the electrode 11 provided on the surface of the solid-electrolyte body 10 and the porous protective layer 12 which covers the surface of the electrode 11. The solid-electrolyte body 10 has in its interior a standard-gas chamber 100 into which a standard gas is to be introduced from the base tail portion 102, and has an internal electrode 15 on the inside surface of the standard-gas chamber 1.

The gas sensor element 1 of this Example can measure oxygen concentration in measurement gases present outside the gas sensor element by applying a voltage between the electrode 11 and the internal electrode 15.

Not shown in the drawings, a rodlike ceramic heater is installed in the standard-gas chamber 100, and the solid-electrolyte body 10 is provided with a lead which is electrically connected with the electrode 11 and the internal electrode 15, for applying a voltage to the electrodes 11 and 15 and taking out output.

A method of manufacturing the gas sensor element 1 according to this Example is described below.

First, a solid-electrolyte body 10 formed of zirconia ceramic is produced from a powder material containing zirconia or yttria.

Then, the electrode 11 is formed on the electrode-forming surface in the surface area of the solid-electrolyte body 10. The internal electrode 15 and the lead (not shown) are also formed together when the electrode 11 is formed. As methods for forming these, any of electroless plating, electroplating, vacuum evaporation and chemical vapor deposition may be used. Besides, a method is available in which the electrode-forming surface is coated with a metal salt containing a metal material for electrodes, followed by heating to make the metal material for electrodes decompose on and adhere to the surface to form the electrode.

Next, the porous protective layer which covers the electrode 11 is formed using the plasma thermal-spraying equipment 2 shown in FIG. 2, by spraying the protective layer forming material 230 on the protective-layer-forming surface 120 by plasma thermal spraying.

Here, the plasma thermal spraying is carried out using a plasma gun 21. Under application of a high voltage between the cathode center electrode and the anode nozzle, the plasma gun 21 generates an arc in the state a plasma power of 20 to 30 KW is retained between both the electrodes, where an orifice gas composed of Ar gas or the like is fed from its rearward to bring it into plasma. The gas brought into plasma causes volume expansion, and spurts from a nozzle outlet 210 in the form of high-temperature and high-velocity plasma jet 22.

Then, a heat-resistant metal oxide (spinel in this Example) serving as the protective-layer material 230 is injected from a feeder 23 into the plasma jet 22 spurting from the nozzle outlet 210, where this protective-layer material 230 is made to melt and accelerate to continuously collide against the target, the protective-layer-forming surface 120 of the solid-electrolyte body 10.

Here, the solid-electrolyte body 10 is fastened to a rotatable jig 19, and is rotated together with the jig 19, during which the plasma gun 21 is moved in the directions shown by an arrow 25 to make a molten protective-layer material 230 adhere to the whole protective-layer-forming surface 120. The jig 19 consists of a holder 191 and a cap 192.

Incidentally, the movement of the plasma gun 21 and the feeder 23 is controlled by a control unit 24.

A method of controlling the formation of the protective layer 12 in a desired thickness is described below.

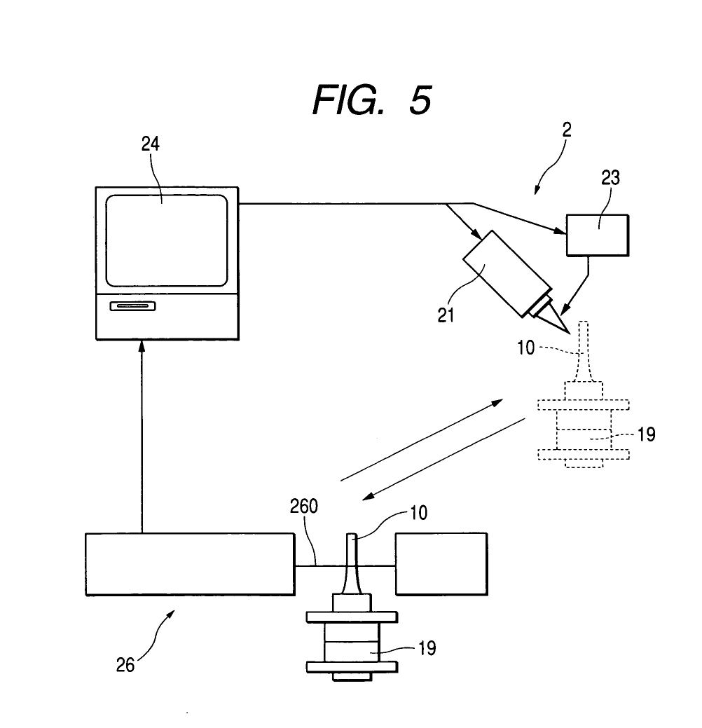

As shown in FIGS. 3 and 5, the radius R of the solid-electrolyte body 10 is measured with a laser displacement meter 26 at the radius measurement position A of the protective-layer-forming surface 120 of the solid-electrolyte body 10.

The laser displacement meter 26 emits a parallel-scanned laser beam 260 to irradiate the solid-electrolyte body 10 at its radius measurement position A, and two-dimensionally measures the position of linearly arranged light points formed by this irradiation, to measure the radius R. The value of the radius R measured with the laser displacement meter 26 is sent to the control unit 24.

Thereafter, the protective layer 12 is formed on the solid-electrolyte body 10 by means of the plasma thermal-spraying equipment 2 in the manner described previously.

Subsequently, as shown in FIGS. 4 and 5, the radius S of the solid-electrolyte body 10 inclusive of the protective layer 12 is measured with the laser displacement meter 26 at the point B of intersection of a normal at the radius measurement position A with the surface of the protective layer 12. The measured value of the radius S is sent to the control unit 24.

The difference between the radius S and the radius R (S−R) is found in the control unit 24. When this value is smaller than a standard value, the control unit 24 judges that the thickness of the protective layer 12 does not reach the desired thickness, and controls the plasma gun 21 and feeder 23 so as to increase the amount of the protective-layer material 230 to be injected into the plasma jet 22, to make the amount of thermal spraying larger.

On the contrary, when the difference of S−R is larger than the standard value, the control unit 24 judges that the thickness of the protective layer 12 has come larger than the desired thickness, and controls the plasma gun 21 and feeder 23 so as to decrease the amount of the protective-layer material 230 to be injected into the plasma jet 22.

Thus, in this Example, in manufacturing a large number of gas sensor elements 1 continuously, the amount of the protective-layer material 230 to be thermal-sprayed is increased or decreased making reference to the thickness of the protective layer 12 at the part between the radius measurement position A and the intersection point B in respect of a gas sensor element 1 manufactured directly previously.

More specifically, in this Example, the control is made regarding the thickness at the part between the radius measurement position A and the intersection point B at one point as the thickness of the whole protective layer 12. However, the radius measurement position A and the intersection point B are selected at random from those of a large number of solid-electrolyte bodies. Hence, according to this Example, gas sensor elements 1 can be manufactured which have less thickness scattering of protective layers 12.

Thus, the invention in this Example makes it possible to provide a method of manufacturing gas sensor elements with less responsivity scattering.

In addition, as shown in FIGS. 3 and 4, the radius measurement position A may be selected for each solid-electrolyte body 10 in such a way that a distance t from the top 105 of the head portion 101 of the solid-electrolyte body 10 along the axis G (i.e., the distance from the top 105 to an intersection point of the axis G with the normal at the radius measurement position A) comes equal to one another.

The spot having equal distance from the top 105 in the area of the protective-layer-forming surface 120 is thermal-sprayed under substantially the same conditions. Thus, the thicknesses of protective layers 12 can be uniformed with less scattering, compared with a case in which radius measurement positions A are employed from other positions having different distance t in each solid-electrolyte body 10.

### EXAMPLE 2

In this Example, a protective-layer formation apparatus is described which is used to form protective layers on solid-electrolyte bodies while measuring their radii as shown in Example 1 and subsequent Example 3 when gas sensor elements are manufactured.

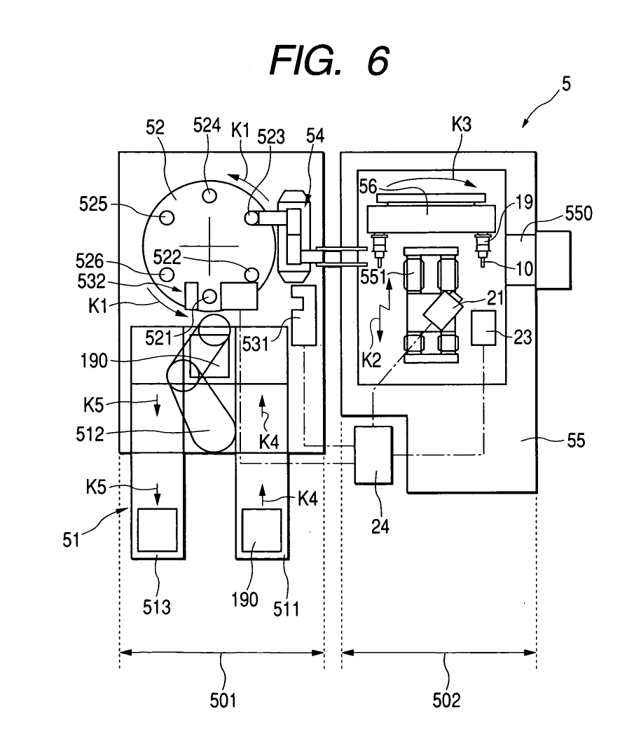

As shown in FIG. 6, a protective-layer formation apparatus 5 consists of a loading equipment 501 and a plasma thermal-spraying equipment 502. In the loading equipment 501, it feeds solid-electrolyte bodies 10 to the plasma thermal-spraying equipment 502, and also collects solid-electrolyte bodies 10 on which protective layers have been formed, from the plasma thermal-spraying equipment 502.

The loading equipment 501 has a pallet transporter 51 for transporting a pallet 190 carrying solid-electrolyte bodies 10, a robot arm 512 for transporting each solid-electrolyte body 10 from the pallet 190 to an index table 52 or collecting from the index table 52 each solid-electrolyte body 10 on which the protective layer has been formed, a shifting loader 54 for transporting each solid-electrolyte body 10 between the index table 52 and the plasma thermal-spraying equipment 502, and two laser displacement meters 531 and 532.

One laser displacement meter 532 measures the radius of each solid-electrolyte body 10 at the radius measurement position in the state the protective layer has not been formed. The other laser displacement meter 531 measures at the radius measurement position the radius of each solid-electrolyte body 10 on which the protective layer has been formed.

The plasma thermal-spraying equipment 502 consists basically of a plasma gun 21, a stand 551 for the plasma gun 21, a feeder 23 for feeding a protective-layer material to the plasma gun 21, and an index table 56 for setting thereon each solid-electrolyte body 10 together with a jig 19, which are provided inside a soundproofing box 55 having a dust collection opening 550. Outside the soundproofing box 55, a control unit 24 is provided which controls the plasma gun 21 and feeder 23.

The index table 56 is a disk installed in the direction perpendicular to the paper surface as viewed on the drawing, and fastens each solid-electrolyte body 10 which is so fitted with the jig 19 as to look downward as viewed on the drawing. The index table 56 is also rotated in the direction shown by an arrow K3 directed from the left to the right as viewed on the drawing. The laser displacement meters 531 and 532 in the loading equipment 501 are also so constructed that they send out detected values to the control unit 24 for controlling the plasma gun 21 and feeder 23 in the plasma thermal-spraying equipment 502.

How the above protective layer formation apparatus 5 operates is described below.

A stated number of solid-electrolyte bodies 10′ (not shown) on which protective layers have not been formed are carried on the pallet 190, and this pallet 190 is loaded into a pallet loading section 511 of the pallet transporter 51. This pallet 190 is transported by the pallet transporter 51 in the direction shown by arrows K4 up to the position of the robot arm 512.

The solid-electrolyte bodies 10′ on which protective layers have not been formed are fed from the pallet 190 to the index table 52 by means of the robot arm 512.

The index table 52 is rotated in the direction shown by an arrow K1, anticlockwise as viewed on the drawing, and has holders 191 (see FIG. 2) for holding the solid-electrolyte bodies 10 at spots corresponding to reference numerals 521 to 526.

The feeding of each solid-electrolyte body 10′ by means of the robot arm 512 is performed in respect to an empty holder 191 present at the spot corresponding to the reference numeral 521.

Where any solid-electrolyte body 10 on which the plasma thermal spraying has been completed and the protective layer has been formed is present on the index table 52, the solid-electrolyte body 10 on which the protective layer has been formed is collected together with the feeding (to the index table 52) of a solid-electrolyte body 10′ on which the protective layer has not been formed, and is carried on the pallet 190, changing off with the solid-electrolyte body 10′ on which the protective layer has not been formed. Then, after the pallet 190 has been filled with solid-electrolyte bodies 10 on which protective layers have been formed, the pallet 190 is transported by the pallet transporter 51 along arrows K5, and then guided out of the loading equipment 501 from a pallet delivery section 513.

The index table 52 is rotated, and the holder 191 having a solid-electrolyte body 10 is moved to the spot corresponding to the reference numeral 522. Here, a cap 192 (see FIG. 2) is fitted to the holder 191. Incidentally, the fitting of the cap 192 to the holder 191 makes up the jig 19 described in Example 1.

Next, at the spot corresponding to the reference numeral 523 of the index table 52, the solid-electrolyte body 10 is shifted together with the jig 19, and is sent out to the plasma thermal-spraying equipment 502 by utilizing the shifting loader 54.

Where any solid-electrolyte body 10 on which the protective layer has been formed is present in the plasma thermal-spraying equipment 502, the solid-electrolyte body 10 on which the protective layer has been formed in the plasma thermal-spraying equipment 502 is returned to the index table 52 simultaneously with the sending of a solid-electrolyte body 10′ on which the protective layer has not been formed.

That is, the solid-electrolyte body 10′ on which the protective layer has not been formed and the solid-electrolyte body 10 on which the protective layer has been formed are changed off with each other at the spot corresponding to the reference numeral 523.

The index table 52 is rotated, and the solid-electrolyte body 10 on which the protective layer has been formed is moved to the spot corresponding to the reference numeral 525 via the spot corresponding to the reference numeral 524. Here, the cap 192 of the jig 19 is detached.

The index table 52 is further rotated, and the solid-electrolyte body 10 on which the protective layer has been formed is transported to the spot corresponding to the reference numeral 521 via the spot corresponding to the reference numeral 526. Here, the robot arm 512 collects from the holder 191 the solid-electrolyte body 10 on which the protective layer has been formed, and carries it on the pallet 190 as described previously.

Now, the solid-electrolyte body 10′ on which the protective layer has not been formed is set on the index table 56 in the plasma thermal-spraying equipment 502 together with the jig 19, from the index table 52 by means of the shifting loader 54.

Thereafter, the index table 56 is rotated, and the solid-electrolyte body 10′ on which the protective layer has not been formed is transported to the vicinity of the plasma gun 21. Here, the plasma thermal spraying is performed in the manner described in Example 1, to form the protective layer on the solid-electrolyte body 10.

The stand 551 for the plasma gun 21 is so structured as to be movable in the directions shown by an arrow K2, to make it easy to form the protective layer on the solid-electrolyte body 10 by plasma thermal spraying.

The solid-electrolyte body 10 on which the protective layer has been formed is, as the index table 56 is rotated together with the jig 19, returned to the vicinity of the shifting loader 54. As described previously, the solid-electrolyte body 10 on which the protective layer has been formed here is returned to the index table 52 in the loading equipment 501.

The radius measurement is described below.

In respect to each solid-electrolyte body 10′ on which the protective layer has not been formed, the radius R of the solid-electrolyte body 10′ at the radius measurement position A (see Example 1 and FIG. 3) is measured with the laser displacement meter 532.

The radius S at the radius measurement position B of the solid-electrolyte body 10 on which the protective layer has been formed is also measured with the laser displacement meter 531 while the solid-electrolyte body 10 on which the protective layer has been formed is held on the shifting loader 54.

The measured values of these are sent to the control unit 24, which calculates the value of S−R, and controls the plasma gun 21 and feeder 23 on the basis of this value. Thus, when protective layers are continuously formed on solid-electrolyte bodies 10, protective layers with stated thicknesses can be formed by the plasma gun 21 and so forth controlled on the basis of the thickness of a protective layer formed directly previously.

### EXAMPLE 3

A method is described in which radii are measured at 180 points of radius measurement positions and the control unit and feeder of the plasma thermal-spraying equipment are controlled on the basis of the resulting measured values. The apparatus described in Example 2 is used as a protective layer formation apparatus used to form protective layers in this Example.

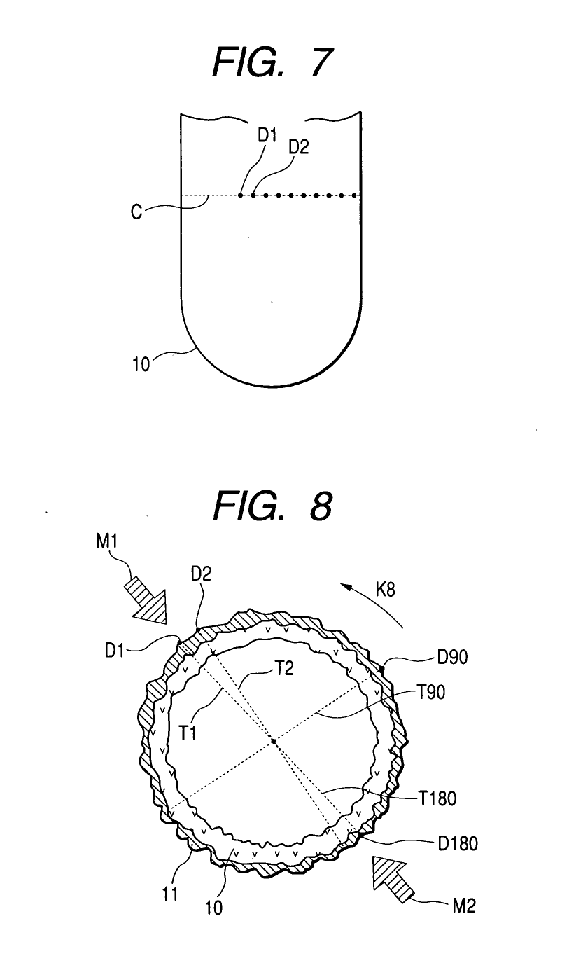

In this Example, as shown in FIGS. 7 and 8, radius measurement positions D1,D2 . . . D90 . . . D180 are allocated at intervals of 1° on each solid-electrolyte body 10, and radii T1,T2 . . . T90 . . . T180 are measured at the respective radius measurement positions.

As shown in FIG. 8, on each solid-electrolyte body 10 (inclusive of an electrode layer 11) having uneven surface and on which the protective layer has not been formed, the radius T1 is measured with the laser displacement meter at the radius measurement position D1 from the direction connecting arrows M1 and M2.

Next, the solid-electrolyte body 10 is rotated by 1° in the direction of an arrow K8, and the radius measurement position D2 is brought into agreement with the direction connecting the arrows M1 and M2, where the radius T2 is measured. This is repeated until finally the radius measurement position D180 which is 180° away from the D1 is brought into agreement with the direction connecting the arrows M1 and M2, where the radius T180 is measured.

After the protective layer is formed by plasma thermal spraying in the manner described in Example 1 or 2, as shown in FIG. 9, the same procedure as the above is repeated in respect of intersection points E1 to E180 on the solid-electrolyte body 10 to measure radii U1 to U180.

The data obtained by the above measurement are sent to the control unit 24.

In the control unit 24, it calculates {(U1−T1)+(U2−T2)+. . . +(U90−T90)+. . . +(U180−T180)}/180. Thus, an average thickness of the protective layer is found.

On the basis of this average thickness, the control unit 24 and feeder 23 of the plasma thermal-spraying equipment 502 are controlled (see Examples 1 and 2) to form each protective layer having a stated thickness. This enables manufacture of gas sensor elements with a small thickness scattering of protective layers.

Incidentally, FIGS. 8 and 9 are diagrammatic views of a cross section at the peripheral circle C shown in FIG. 7, and how uneven surfaces of the solid-electrolyte body 10 and so forth stand is illustrated in an exaggerated manner so as to be intelligible. The solid-electrolyte body 10 of the gas sensor element also has an internal electrode (see FIG. 1), which, however, is also omitted from illustration.

### EXAMPLE 4

Hundred (100) gas sensor elements were manufactured by a method of finding the thickness of each protective layer by measuring its diameter at one radius measurement position as in Example 1. The gas sensor elements obtained by this manufacturing method came found to be 12 μm as 6σ (six sigma; a measure of dispersion of a population) in thickness scattering of protective layers.

Hundred (100) gas sensor elements were also manufactured by a method of, as in Example 3, finding the average thickness of protective layers by measuring their diameters at 180 spots of radius measurement positions while rotating each solid-electrolyte body. The gas sensor elements obtained by this manufacturing method came found to be 1.5 μm as 6σ in thickness scattering of protective layers.

As a Comparative Example, hundred (100) gas sensor elements were also manufactured so controlling the output of plasma thermal spraying as to be kept within a stated range per unit time diameters at 180 spots of radius measurement positions while rotating each solid-electrolyte body. The gas sensor elements obtained by this manufacturing method came found to be 37 μm as 6σ in thickness scattering of protective layers.

As described above, it has turned out that the utilization of the present invention enables manufacture of gas sensor elements with a small thickness scattering of protective layers.

What is claimed is:

1. A method for manufacturing gas sensor elements each having i) a cylindrical and substantially tumbler-shaped solid-electrolyte body which has a closed-end head portion and, on the side opposite to the head portion, an open-ended base tail portion, ii) an electrode provided on the surface of the solid-electrolyte body and iii) a porous protective layer which covers the surface of the electrode; the method comprising:
forming the electrode on an electrode-forming surface of the solid-electrolyte body;
subsequently measuring a radius R of the solid-electrolyte body, at a radius measurement position A of a protective-layer-forming surface of the solid-electrolyte body;
spraying a molten protective-layer material on the protective-layer-forming surface by means of a plasma thermal-spraying equipment to form the protective layer;
measuring a radius S of the solid-electrolyte body inclusive of the protective layer, at a point B of intersection of a normal at the radius measurement position A with the surface of the protective layer; and
controlling the amount of spray of the protective-layer material in the plasma thermal-spraying equipment, regarding a difference between the radius S and the radius R as the thickness of the protective layer and on the basis of this thickness, to form each protective layer in a desired thickness.

2. The manufacturing method according to claim 1, wherein said gas sensor elements are continuously manufactured in a large number, and the amount of spray of said protective-layer material is increased or decreased making reference to the thickness of each protective layer at the part between the radius measurement position A and the intersection point B in respect of a gas sensor element manufactured directly previously.

3. The manufacturing method according to claim 2, wherein said radius measurement position A and said intersection point B are selected at random from those of a large number of solid-electrolyte bodies.

4. The manufacturing method according to claim 3, wherein said radius measurement position A is selected for each solid-electrolyte body in such a way that a distance from the top of the head portion of each solid-electrolyte body to an intersection point of the axis of each solid-electrolyte body with the normal at the radius measurement position A comes equal to one another.

5. A method for manufacturing gas sensor elements each having i) a cylindrical and substantially tumbler-shaped solid-electrolyte body which has a closed-end head portion and, on the side opposite to the head portion, an open-ended base tail portion, ii) an electrode provided on the surface of the solid-electrolyte body and iii) a porous protective layer which covers the surface of the electrode; the method comprising:
forming the electrode on an electrode-forming surface of the solid-electrolyte body;
subsequently measuring radii T1,T2 . . . of the solid-electrolyte body at a plurality of radius measurement positions D1,D2 . . . selected along a peripheral circle C on a protective-layer-forming surface of the solid-electrolyte body while rotating the solid-electrolyte body around its axis extending along the axial direction connecting the base tail portion and the head portion;
spraying a molten protective-layer material on the protective-layer-forming surface by means of a plasma thermal-spraying equipment to form the protective layer;
measuring radii U1,U2 . . . of the solid-electrolyte body inclusive of the protective layer, at points E1,E2 . . . of intersection of normals at the radius measurement positions D1,D2 . . . with the surface of the protective layer; and
controlling the amount of spray of the protective-layer material in the plasma thermal-spraying equipment, regarding an average of differences between the radii T1,T2 . . . at the respective radius measurement positions and the radii U1,U2 . . . at the respective intersection points corresponding to the former as the thickness of the protective layer and on the basis of this thickness, to form each protective layer in a desired thickness.

6. The manufacturing method according to claim 5, wherein said gas sensor elements are continuously manufactured in a large number, and the amount of spray of said protective-layer material is increased or decreased making reference to the thickness of a protective layer formed directly previously.

7. The manufacturing method according to claim 5, wherein;
said radius measurement positions D1,D2 . . . are allocated at intervals of 1° at maximum up to D180 at maximum on each solid-electrolyte body, and radii T1,T2 . . . up to T180 at maximum are measured at the respective radius measurement positions; and
said radius measurement positions E1,E2 . . . are allocated at intervals of 1° at maximum up to E180 at maximum on each solid-electrolyte body, and radii U1,U2 . . . up to U180 at maximum are measured at the respective radius measurement positions.
